(19) United States
(12) Patent Application Publication
(10) Pub. No.: US 2005/0191479 A1
(43) Pub. Date: Sep. 1, 2005

(54) Reinforced panel

(76) Inventor: Reginald B. Harder, Gretna (CA)

Correspondence Address: Robert W.B. Bailey;Box 2, Station L, Winnipeg, MB, R3H 0Z4, CA

(21) Appl. No.: 10/788,280

(22) Filed: Mar. 1, 2004

(51) Int. Cl. B32B 3/26; B29C 67/00; B32B 5/22; B32B 27/00

(52) U.S. Cl. 428/304.4; 428/317.9; 428/319.7

(57) ABSTRACT

A reinforced panel for tables, counters, desks, benches, etc. has a foamed polyurethane core reinforced by feather barbs, with top and bottom layers of solid polyurethane reinforced by chopped fiberglass. The top layer has a color gel coat resin coating and a surface coating containing granite particles. The panel is manufactured by spraying the surface coating, then the color gel coat resin in the mold top, then polyurethane precursors and chopped fiberglass in the mold top and bottom. A slurry of polyurethane precursors, feather barbs and blowing agent is poured into the mold. The mold is closed, and the polyurethane precursors are cured and foamed, vacuum may be applied to fill voids during foaming.

This invention relates to reinforced panels for tables, tabletops, countertops, desks, benches and products with similar uses limited only by imagination of those skilled in the art.

The invention includes a reinforced panel, with a foamed resin preferably polyurethane core, reinforced by feather barbs, which is unaffected by heat, moisture and cold, and is light, durable, and strong. Feathers have two portions the quill and barbs growing from the quill. The separated barb portion is used as reinforcement. The reinforced preferably polyurethane core is sandwiched between chopped fiberglass (or chopped glass fiber) reinforced solid preferably polyurethane layers, the lower or bottom of which may contain a fire retardant. Preferably there is a top or outer surface which is functional in that it will not crack craze or chip under normal use indoors and outdoors. Preferably the surface is both decorative in that it can be colored and durable in that it can be repaired. A surface coating is present which may contain granite particles or the like.

The invention also includes a process of manufacture of reinforced panels, which involves spraying and pouring the various layers in a clamshell mold, then curing (all layers) and foaming (the foamed core) in the mold.

Although the invention is described and referred to specifically as it relates to specific panels with feather reinforced foamed resin cores and fiberglass reinforced solid resin layers and methods of manufacture thereof, it will be understood that the principles of this invention are equally applicable to similar reinforced resin panels and methods of manufacture thereof and accordingly, it will be understood that the invention is not limited to such panels and methods of manufacture thereof.

### PRIOR ART

As the foamed preferably polyurethane layer is reinforced by feather barbs, the closest relevant art is U.S. Pat. No. 5,705,030 issued 6 Jan. 1998, Gassner, III, et al., hereby incorporated by reference, who teach processing feathers, principally from chickens, although in principle any feathers can be used. The feathers are cleaned by washing in organic solvent, to remove fat and oil, sanitize, and partly dehydrate the feathers. The barbs or fibers are separated from the quill or shaft by mechanical means to form a fiber pulp. The barbs may be mostly intact and range from 2 cm (0.8 inch) to 4 or 5 cms (1½ to 2 inches) in length. They may also be chopped to 40 or 50 microns (μm) in length. Although not stated by Gassner they are available in 80 micron (μm). Typically chicken flight feathers provide fibers or barbs up to 1½ inches (3¾ cm) long. These feathers can be used in the current invention.

Feather barbs or fibers are said to have a structure that is of the honey comb type with hexagonal cell structure, which is both very strong and very light. Regardless of this assertion, feather barbs are in fact extremely strong and light, and suitable for use as reinforcement.

The prior art relating to resin coatings and layers and the like is of encyclopedic scope, encompassing entire classes within the patent classification, so that it is difficult, if not impossible, and probably invidiously misleading, to single out especially relevant individual patents and publications.

A principal object of the invention is to provide a reinforced panel having a foamed polyurethane core reinforced by feather barbs and having upper and lower layers of solid polyurethane resin reinforced by fiberglass (chopped glass fiber) contacting the core. It is a subsidiary object of the invention that the upper layer of fiberglass reinforced polyurethane resin extends down the sides of the core to meet the lower layer of fiberglass reinforced resin. It is a further subsidiary object of the invention to have a surface gel coat on the top of the upper polyurethane layer. It is a further subsidiary object of the invention that the surface gel coat be colored. It is a further subsidiary layer that the surface gel coat be reparable. It is a further subsidiary object of the invention that a surface coating containing granite be provided outside the surface gel coat. It is a further subsidiary object of the invention that at least the lower fiberglass reinforced polyurethane layer contain fire retardant. It is also a principal object to provide a method of molding a reinforced panel comprising the steps of spraying a mold top and bottom with resin mixed with chopped fiberglass and then pouring a slurry of the resin mixed with feather barbs and blowing agent into said mold and curing and foaming said resin in said mold. It is a subsidiary object that the resin is polyurethane precursors. It is a further subsidiary object that vacuum be applied during curing and foaming. It is a further subsidiary object to spray at least the mold top with a color gel coat resin before spraying the resin and chopped fiberglass. It is a further subsidiary object to spray the top mold with a surface coating before spraying the color gel coat resin. It is a further subsidiary object to utilize avian feather barbs, conveniently fowl feather barbs, more preferably waterfowl feather barbs, even more preferably domestic fowl feather barbs, and most preferably domestic waterfowl feather barbs. Other objects will be apparent to those skilled in the art from the following specification, accompanying drawings and appended claims.

### DESCRIPTION OF THE INVENTION

In one broad aspect the invention is directed to a reinforced panel comprising a cured foamed resin core reinforced with feather barbs. The panel has upper and lowers surface and edges between said surfaces. These surfaces are covered respectively by upper and lower layers of solid cured resin reinforced by chopped fiberglass. Preferably the resin is polyurethane. The polyurethane may contain crosslinking agents, fillers, dyes, pigments, reinforcing agents, and similar additives as known to those skilled in the art. Preferably the upper and lower layers meet at the edges. More preferably the upper surface is coated with a gel coat resin layer, usually containing color. Preferably the gel coat resin layer itself has a surface coating of a granite containing gel coat resin. The lower surface may be coated with a gel coat resin layer. The feather barbs are about 5 to about 80% by volume, of the core and at least about 80 microns long. These feather barbs are preferably those from flight feathers having lengths in the case of chicken feathers up to about 1½ inches (3¾ cm), other feathers may be used, such as duck, geese and turkey flight feather barbs, which are longer, body feather barbs which are shorter, and chopped feather barbs, which may be as short as 80 microns (μm) or even shorter, 40 microns (μm), for example. Feather barbs from just about any species however exotic may be used, Grassman for example refers to ostrich and peacock feather barbs. As those skilled in the art are aware the commonest available feather barbs are those from domestic poultry used for food. Avian feather barbs, conveniently fowl feather barbs, more preferably waterfowl feather barbs, even more preferably domestic fowl feather barbs, and most preferably domestic waterfowl feather barbs may be used. The solid cured polyurethane layers comprise chopped fiberglass from about 10 to 30% by volume, except at the corners where they may be up to about 50% by volume.

In another broad aspect the invention is directed to a reinforced panel comprising a cured foamed polyurethane resin core reinforced with about 5 to about 80% by volume of feather barbs having a length of at least 80 microns (μm). The core is from about ¼ to about 1 inch, its upper and lower surfaces are covered respectively by upper and lower layers of solid cured polyurethane resin reinforced by 10 to 30% by volume of chopped fiberglass. The upper layer has a thickness of from about 1/16 to about ¼ inch. The lower layer has a thickness from about 1/32 to about 1/16 inch. The upper layer has a cured gel coat color resin coating about 10 mils thick, itself with a surface coating of a cured gel coat resin comprising granite particles about 1 mil thick. Optionally the lower layer has a cured gel coat color resin coating about 10 mils thick.

In a third broad aspect the invention is directed to a method of molding a reinforced panel comprising the steps of spraying a clam shell mold top and bottom with neat polyurethane precursors to form a thin layer. Then the same polyurethane precursors mixed with chopped fiberglass are sprayed onto the thin layer, top and bottom. Next a slurry of the polyurethane precursors mixed with feather barbs and blowing agent are into the mold which is closed and heated to cure and foam the polyurethane precursors. Vacuum may be applied while foaming the polyurethane precursors, to fill any voids. Preferably the clam shell mold top is sprayed with gel coat color resin before spraying the neat polyurethane precursors. More preferably the clam shell mold top is sprayed with gel coat granite particle resin before spraying the gel coat color resin. Optionally the mold bottom is sprayed with gel coat color resin before spraying the neat polyurethane precursors.

### BRIEF DESCRIPTION OF THE DRAWINGS

FIG. 1 shows a sectional view of a reinforced panel of the invention.

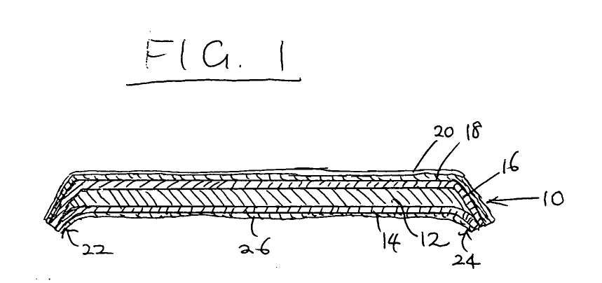

### DESCRIPTION OF THE PREFERRED EMBODIMENT

Numeral 10 indicates a reinforced panel of the invention, which has a cured foamed polyurethane resin core 12, reinforced by chicken feather barbs. Lower layer 14 and upper layer 16 are solid cured polyurethane resin reinforced by chopped fiberglass (glass fibers). The polyurethane resin in core 12 and layers 14 and 16 is identical and integrally bonded. The boundaries shown between layers 14 and 16 containing fiber glass and core 12 containing feather barbs represent a change of composition only, the polyurethane resin itself is continuous and identical throughout the layers. Layers 14 and 16 merge into each other at edges 22 and 24. The polyurethane core is composed of foamed polyurethane resin, typically when foamed the polyurethane is 5 or 10 lbs/cubic foot (density 0.08 or 0.016), although in theory it can be as foamed as light as 1½ lbs/cubic foot or solid 62½ lbs/cubic foot (density 0.025 to 1). Generally the foamed polyurethane core has a density of about 8 lbs/cubic foot or about 0.13. The polyurethane core is composed of a cured mixture of foamed polyurethane precursors (polyols and polyisocyanates) and feather barbs, the feather barbs comprising from 5% to 80% by volume of the mixture. 5%, 10%, 20%, 30%, 40%, 50%, 60%, 70% and 80% mixtures were formed. It as obvious from inspection, that 80% by volume of chicken feather barbs was approaching the limit of practicality. The volume of feather barbs in the foamed polyurethane was calculated by relative volume as mixed with the original slurry. Core 12 is typically from about ½ inch to about 1 inch thick (13 to 25 mm). Layers 14 and 16 are typically from about 1/32 to about ¼ inch thick (about 1 to 6 mm), more preferably lower layer 14 is from about 1/32 to about 1/16 inch thick (about 1 to 1½ mm), while upper layer 16 is from about 1/16 to 3/32 to about ¼ inch thick (about 1 to 6 mm). The volume of chopped fiberglass is typically from about 10 to 30% by volume, rising to 50% by volume at the panel corners. Chopped fiberglass is used because it was found that under the conditions of manufacture that fiberglass mats tended to give air entrapment. Layers 14 and 16 form a hard damage resistant coat. layer 18 is a gel coat resin back color layer, typically about 10 mils thick (about ¼ mm), although it can vary from 5 to 70 mils (⅛ to 1¾ mm), the gel coat is composed of cured unsaturated polyester-monomer, sometimes with admixtures of other monomers and polymers. The gel coat resin has conventional additives known to those skilled in the art typically including a dye and filler. Optional bottom gel coat resin layer 26 may be applied to the bottom of panel 10. Finally surface coating 20 is a granite particle filled layer, often gel coat resin, or compatible therewith, and about 1 mil thick (0.025 mm). Other material may be used instead of granite particles. Surface coating 20 can be considerably thicker, but this is not usually desirable or necessary. In the molding process the granite gel coat surface coating is sprayed into a clamshell mold, followed by the back color gel coat layer, optionally top and bottom. Then the polyurethane layers are sprayed both on top and bottom of the mold, at first neat, then mixed with chopped fiberglass. Then the polyurethane-feather barb-blowing agent slurry is poured into the mold. The mold is then closed and placed in a press and the polyurethane cured and foamed for about 4 minutes. The foam is allowed to expand to fill voids, vacuum may be applied at this stage. The edges of the panel are trimmed post molding.

As those skilled in the art would realize these preferred described details and materials and components can be subjected to substantial variation, modification, change, alteration, and substitution without affecting or modifying the function of the described embodiments.

Although embodiments of the invention have been described above, it is not limited thereto, and it will be apparent to persons skilled in the art that numerous modifications and variations form part of the present invention insofar as they do not depart from the spirit, nature and scope of the claimed and described invention.

1. Reinforced panel comprising a cured foamed resin core reinforced with feather barbs, having an upper and lower surface and edges between said surfaces, said surfaces being covered respectively by upper and lower layers of solid cured resin reinforced by chopped fiberglass.

2. Panel of claim 1, wherein said resin is polyurethane.

3. Panel of claim 2, wherein said upper and lower layers meet at the edges.

4. Panel of claim 3, wherein said upper surface is coated with a gel coat resin layer.

5. Panel of claim 4, wherein said gel coat resin layer on said upper surface has a surface coating of granite containing gel coat resin.

6. Panel of claim 4 wherein said lower surface is coated with a gel coat resin layer.

7. Panel of claim 6, wherein said gel coat resin layer on upper surface has a surface coating of granite containing gel coat resin.

8. Panel of claim 2 wherein said cured foamed polyurethane resin core comprises feather barbs from about 5 to about 80% by volume, said barbs being at least about 80 microns long.

9. Panel of claim 8 wherein said solid cured polyurethane layers comprise chopped fiberglass from about 10 to 30% by volume.

10. Panel of claim wherein said solid cured polyurethane layers comprise chopped fiberglass up to about 50% by volume at the corners thereof.

11. Reinforced panel comprising a cured foamed polyurethane resin core reinforced with about 5 to about 80% by volume of feather barbs having a length of at least 80 microns (μm), said core having a thickness of from about ¼ to about 1 inch, said core having an upper and lower surface and edges between said surfaces, said surfaces being covered respectively by upper and lower layers of solid cured polyurethane resin reinforced by 10 to 30% by volume of chopped fiberglass, said upper layer having a thickness of from about 1/16 to about ¼ inch, said lower layer having a thickness from about 1/32 to about 1/16 inch, said upper layer having a cured gel coat color resin coating about 10 mils thick, said gel coat color resin having thereon a surface coating of cured gel coat resin comprising granite particles about 1 mil thick.

12. Panel of claim 11, wherein said lower layer has a cured gel coat color resin coating about 10 mils thick.

13. Method of molding a reinforced panel comprising the steps of spraying a clam shell mold top and bottom with neat polyurethane precursors to form a thin layer and;
spraying said polyurethane precursors mixed with chopped fiberglass onto said thin layer, top and bottom, and;
pouring a slurry of said polyurethane precursors mixed with feather barbs and blowing agent into said mold and;
closing said mold and heating said mold to cure and foam said polyurethane precursors.

14. Method of claim 13 comprising the additional step of applying vacuum while foaming said polyurethane precursors.

15. Method of claim 13 comprising the steps of spraying a clam shell mold top with gel coat color resin and;
spraying neat polyurethane precursors to form a thin layer top and bottom and;
spraying said polyurethane precursors mixed with chopped fiberglass onto said thin layer, top and bottom, and;
pouring a slurry of said polyurethane precursors mixed with feather barbs and blowing agent into said mold and;
closing said mold and heating said mold to cure and foam said polyurethane precursors.

16. Method of claim 15 comprising the additional step of applying vacuum while foaming said polyurethane precursors.

17. Method of claim 15 comprising the steps of spraying a clam shell mold top with gel coat granite particle resin and;
spraying a clam shell mold top with gel coat color resin and;
spraying neat polyurethane precursors to form a thin layer top and bottom and;
spraying said polyurethane precursors mixed with chopped fiberglass onto said thin layer, top and bottom, and;
pouring a slurry of said polyurethane precursors mixed with feather barbs and blowing agent into said mold and;
closing said mold and heating said mold to cure and foam said polyurethane precursors.

18. Method of claim 17 comprising the additional step of applying vacuum while foaming said polyurethane precursors.

19. Method of claim 17 comprising the steps of spraying a clam shell mold top with gel coat granite particle resin and;
spraying a clam shell mold top and bottom with gel coat color resin and;
spraying neat polyurethane precursors to form a thin layer top and bottom and;
spraying said polyurethane precursors mixed with chopped fiberglass onto said thin layer, top and bottom, and;
pouring a slurry of said polyurethane precursors mixed with feather barbs and blowing agent into said mold and;
closing said mold and heating said mold to cure and foam said polyurethane precursors.

20. Method of claim 19 comprising the additional step of applying vacuum while foaming said polyurethane precursors.
